(19) United States
(12) Patent Application Publication
(10) Pub. No.: US 2009/0116020 A1
(43) Pub. Date: May 7, 2009

(54) BIOSENSOR, METHOD FOR PRODUCING THE SAME AND SENSOR MEASUREMENT SYSTEM

(75) Inventors: Yuying Wu, Chiba (JP); Toshio Tokairin, Chiba (JP)

Correspondence Address: KNOBBE MARTENS OLSON & BEAR LLP, 2040 MAIN STREET, FOURTEENTH FLOOR, IRVINE, CA, 92614, US

(73) Assignee: SEIKOH GIKEN CO., LTD., Chiba (JP)

(21) Appl. No.: 12/260,980

(22) Filed: Oct. 29, 2008

(30) Foreign Application Priority Data
Oct. 31, 2007 (JP) 2007-283386

(51) Int. Cl. G01N 21/55; B05D 3/06

(52) U.S. Cl. 356/445; 427/512

(57) ABSTRACT

A biosensor capable of detecting, for example, the index of refraction, the concentration of proteins, or antibody-antigen reactions in a sample using surface plasmon resonance are provided, as well as methods for producing the biosensor sensor measurement systems using the biosensor. A biosensor may comprise transparent rod 2; metallic reflector 40 formed on end surface 2a of one end of transparent rod 2; metallic thin film 3 formed on the outer circumferential surface of said one end of transparent rod 2; and organic substance layer 4 comprising a photo immobilizing agent containing a photo cross linking agent and a substance to be immobilized which is formed on the metallic thin film 3 on the outer circumferential surface and immobilized.

### REFERENCE TO RELATED APPLICATION

This application claims priority to and the benefit of Japanese Patent Application No. 2007-283386, filed on Oct. 31, 2007, in the Japan Patent Office, the disclosure of which is incorporated herein in its entirety by reference.

### BACKGROUND OF THE INVENTION

1. Field of the Invention

The present invention relates to biosensors and methods for producing the biosensor and sensor measurement systems. A biological substance such as a polypeptide, a protein, a nucleic acid or a cell is immobilized on a metallic thin film on the circumferential surface of a transparent rod using a photo immobilizing agent. The biosensor or sensor measurement system may be used, for example, to detect index of refraction, concentration of proteins, or antibody-antigen reaction in a sample, by utilizing surface plasmon resonance.

2. Description of the Related Technology

Surface plasmon resonance phenomenon (SPR) is the phenomenon in which when white light enters to the dielectric which has a metallic thin film of several dozen nanometers thick, evanescent waves generated by a particular incident angle or wave length provide resonance with electronic oscillation on the metallic thin film surface.

Sensors for measuring the index of refraction of a substance by this SPR phenomenon have been developed; for example, a sensor using an optical fiber is developed. Such an optical fiber surface plasmon sensor has been proposed in Washington University in the 1990's and has attracted considerable attention as a compact and simple sensor that is capable of measuring the components or the index of refraction of a solution or a film with high sensitivity in real-time. However, the optical fiber type biosensor still has not been put to practical use, even at the present time because the method for immobilizing the biological substance, such as an antibody or antigen that reacts with the substance to be detected, on the outer circumferential surface of an optical fiber core of a sensor probe has not been established.

On the other hand, though a physical adsorption method or a functional group covalent bond method has been widely known as a method for immobilizing a biological substance such as an antibody or an antigen on a substrate such as a plane shaped plate or chip, there is no case in which a biological substance such as an antibody or an antigen has been successfully immobilized on the outer circumferential surface of an optical fiber core by using these immobilizing methods.

In recent years, a photo immobilizing process for immobilizing a biological substance such as an antibody or an antigen on a substrate such as a plane shaped plate or chip by using a water soluble photo immobilizing agent with a photo reactive group has been developed. This process is capable of eliminating any blocking treatment because of its inhibitory effect on nonspecific adsorption and because it provides high bond sensitivity with the antigen or the antibody of a substance. Such a process is disclosed, for example, in Japanese Patent Laid-Open Publication Nos. 2006-322,708, 2007-139,587 or H10-282,039.

### SUMMARY

An object of the present invention is to provide an optical fiber type biosensor, methods for producing the same and sensor measurement systems which are capable of detecting, for example, the index of refraction, the concentration of proteins, antibody-antigen reaction and the like of a sample by using surface plasmon resonance.

In one aspect, biosensors are provided that comprise a transparent rod, a metallic reflector formed on one end surface of the transparent rod, a metallic thin film formed on the outer circumferential surface of one end of the transparent rod, and an organic substance layer on the metallic thin film, the organic substance layer comprising a substrate that is immobilized through the use of a photo immobilizing agent containing a photo cross linking agent. The material of the transparent rod can be, for example, a quartz glass or an optical glass and the metallic thin film can have a multi-layered structure comprising, for example, a chromium film and a film of gold (Au), silver (Ag), zinc (Zn), aluminum (Al) or potassium (K) formed on the chromium film.

In another aspect, methods for producing a biosensor are provided comprising providing a transparent rod, forming a metallic reflector on one end surface of said transparent rod, forming a metallic thin film on the outer circumferential surface of the end of the transparent rod, and forming an organic substance layer on the metallic thin film of the outer circumferential surface. The organic substance layer includes a substance that can be immobilized by a photo immobilizing agent containing a photo cross linking agent. The material of the transparent rod can be, for example, a quartz glass or an optical glass and the metallic thin film can be, for example, multi-layered comprising a chromium film and a film of gold (Au), silver (Ag), zinc (Zn), aluminum (Al) or potassium (K) formed on the chromium film. The organic substance layer can be formed by dip coating to apply a solution comprising a photo immobilizing agent containing the photo cross linking agent and the substance to be immobilized on the metallic thin film. The dip coating process may comprise is performed by irradiating the metallic thin film of the outer circumferential surface with ultraviolet light to immobilize the photo immobilizing agent.

In yet another aspect, sensor measurement system for detecting substance interaction using surface plasmon resonance are disclosed. The measurement systems comprise a sensor probe including a biosensor for detecting substance interaction by surface plasmon resonance phenomenon as described above, a sensor probe holder for holding the sensor probe, a light source for the sensor probe, a light coupler and a photo detector, where the light coupler is for propagating the incident light from the light source to the sensor probe and, in turn, for transporting the reflected light from the sensor probe to a photo detector which detects the reflected light.

In yet another aspect, photo cross linking agents are provided having a structure comprising two or more photo reactive groups, where the photo reactive group can be an azide group.

The photo immobilizing agent can be formed, for example, by a homopolymer or a copolymer of polyethylene glycol (meth)acrylate which is capable of reducing immobilization by nonspecific adsorption.

In yet another aspect, biological substances that can be immobilized, such as polypeptides, proteins, nucleic acids, lipids and cells, are provided.

In some embodiments, biosensors and sensor measurement systems are produced by methods in which a solution comprising a biological substitute, such as a protein, and a photo immobilizing agent is applied onto a metallic thin film on the outer circumferential surface of a transparent rod, the outer circumferential surface of the transparent rod. The photo immobilizing agent comprises a photo cross linking agent having a photo reacting group. The solution may be dip coated onto the rod and irradiation with an ultraviolet light used to immobilize the coated solution to provide an organic substance layer on the metallic thin film, thereby providing high sensitive detection of, for example, the index of refraction, the concentration of proteins, the antibody-antigen reaction of a sample to be measure by using surface plasmon resonance phenomenon.

### BRIEF DESCRIPTION OF THE DRAWINGS

The claimed methods and apparatuses will be better understood from the Detailed Description of the Preferred Embodiments and from the appended drawings, which are meant to illustrate and not to limit the claims, and wherein:

FIG. 1 is a schematic cross sectional view of a diagram illustrating the optical fiber type biosensor of the first embodiment in accordance with one embodiment.

FIG. 2 is an enlarged schematic cross sectional view of the diagram in FIG. 1 illustrating the optical fiber type biosensor.

FIG. 3 is a schematic diagram illustrating the simple measurement system to which the optical fiber biosensor of an embodiment of the present invention is applied.

FIG. 4 is a schematic diagram illustrating the simple measurement system to which the optical fiber biosensor of an embodiment of the present invention is applied in which a laser diode, LD, a light emitting diode, or LED is used as the light source and a photodiode or PD is used as the detector.

FIG. 5 is a schematic diagram illustrating the simple measurement system to which the optical fiber biosensor of an embodiment of the present invention is applied in which laser diode, LD, arrays, light emitting diode, LED, or arrays are used as the light source and photodiode, PD, or arrays are used as the detector.

FIG. 6 is a graph showing the sample measurement result by using the optical fiber biosensor.

FIG. 7 is a graph showing another sample measurement result by the use of the optical fiber biosensor.

FIG. 8 is a table of the measurement data from FIGS. 6 and 7.

FIG. 9A is a graph showing the relationship between the normalized intensity and the sensing length of the region where the organic substance layer is formed. FIG. 9B is also a graph showing the relationship between the normalized intensity and the sensing length of the region where the organic substance layer is formed.

Panel (A) of FIG. 10 is a schematic cross sectional view of a diagram illustrating a fused type fiber coupler. Panel (B) of FIG. 10 is a schematic cross sectional view of a diagram illustrating a filter type fiber coupler. Panel (C) of FIG. 10 is a schematic cross sectional view of a diagram illustrating a waveguide type fiber coupler.

### DETAILED DESCRIPTION OF CERTAIN INVENTIVE EMBODIMENT

Explanation of Numerical References: 1: sensor probe; 2: transparent rod; 2a: end surface (sensor detecting end surface); 3: metallic thin film; 4: organic substance layer; 4a: reactive layer; 5a: cladding layer; 5b: resin coated layer; 6: sensor probe holder; 7: objective substance to be detected; 10: sensor measurement system; 11: light source; 11a: laser diode or light emitting diode; 11b: laser diode arrays or light emitting diode arrays; 12: detector; 12a: photodiode; 12b: photodiode arrays; 13: optical coupler; 13a, 13b, 13c: optical fibers; 14: sample to be measured; and 40: metallic reflector.

The embodiments of the present invention will now be explained with reference to the drawings. In the accompanying drawings, the same or similar numerical references are applied to the same or similar component. Also it should be noted that the drawings are representative and may differ from practice. In different drawings, different relationships in sizes or ratios of different components are contained.

In addition to the above, the following embodiments embody the technical idea of the present invention and this technical idea of the invention does not limit the arrangement of the components to the following disabled arrangements. Modifications could be added to this technical idea within the scope of accompanying claims.

### Probe Structure of Optical Fiber Type Biosensor

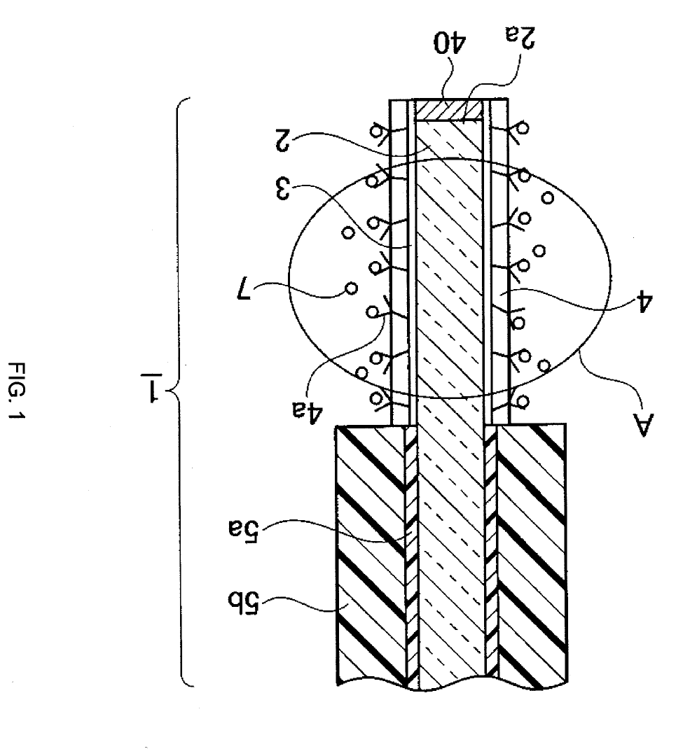

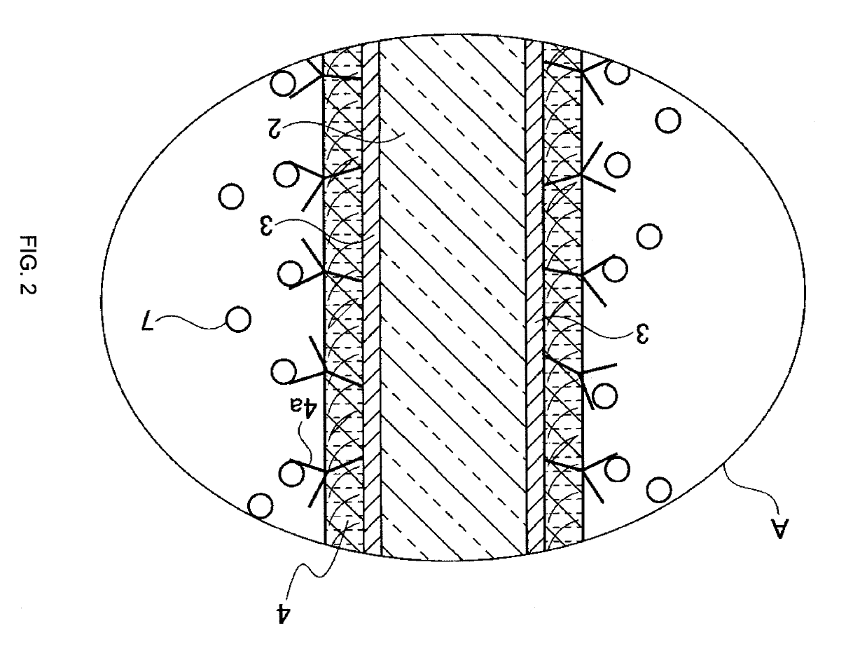

FIG. 1 shows a schematic cross sectional view of a block diagram illustrating a representative sensor probe 1 of an optical fiber type biosensor of the first embodiment according to the present invention. FIG. 2 shows a schematic cross sectional view of a block diagram illustrating the optical fiber type biosensor of the first embodiment according to the present invention, in which the representative sensor probe 1 part is enlarged.

The optical fiber type biosensor of the first embodiment according to the present invention, as shown in FIGS. 1 and 2, includes a transparent rod 2, a metallic reflector 40 formed on the end surface (sensor detecting end surface) 2a of one end of the transparent rod 2, a metallic thin film 3 formed on the outer circumferential surface of said one end of the transparent rod 2, and an organic substance layer 4 formed on the metallic thin film 3 of the outer circumferential surface, wherein a photo immobilizing agent containing a photo cross linking agent and a substance to be immobilized are immobilized in the layer. The photo cross linking agent has at least two (2) or more of photoreactive groups in one molecule and the photo reactive group may be an azide group. The photo immobilizing agent may be an aqueous solution of polyethylene glycol (meth)acrylate which reduces immobilization of the substance from nonspecific adsorbance. The substance to be immobilized may be a biological substance such as a polypeptide or protein, a nucleic acid, a lipid or a cell. Furthermore, for the material of the transparent rod 2, the commercially available quartz glass, an optical glass such as BK7 (trademark) or an optical polymer such as PMMA may be employed.

The outer diameter of the transparent rod is not specifically limited but may be, for example, in the range from approximately 5 micrometers to 5,000 micrometers, more preferably, in the range from approximately 100 micrometers to 600 micrometers. When this outer diameter of the transparent rod is increased, the measurable wave length band can be widened. In other word, when the core part of an optical fiber is used as a transparent rod, NA (Numerical Apertures; hereinafter, also referred to “the number of apertures”) could be enlarged as the outer diameter is increased.

In the biosensor according to the present invention, when the index of refraction of the transparent rod is n1 and the index of refraction of the coating layer coating the portion other than the metallic thin film of the transparent rod, it is preferred that n1 is greater than n2 and they fall in the range of 0.10<(n12−n22))½<0.80. For example, when n1 is 1.475 and n2 is 1.428, (n12−n22)½ is 0.37. By regulating the relationship between the index of refraction n1 and the index of refraction n2 the coating layer of such a transparent rod, the light entered from the light source is contained in the transparent rod to hinder the dropping thereof from the side surface. Further, the cross sectional shape of the transparent rod may be any one of a circle, an ellipse and a rectangular. Herein, the circle represents circles that are substantially processed or made, including a perfect circle.

For a metal employed as the metallic thin film 3, for example, Ag, Au, Cu, Zn, Al, K are preferred, in particular, Ag and Au are desired. The metallic thin film 3 is formed by depositing an selected metal on the side surface of the transparent rod by, for example, vacuum deposition, sputtering, plating or the like. The thickness of the metallic thin film 3 is not specifically limited but may be, for example, in the range from approximately 10 nm to 80 nm, more preferably, in the range from approximately 30 nm to 60 nm so long as SPR is generated therewith. The metallic thin film 3 may be composed of an alloy composition.

It is preferred that, however, a highly densified metallic thin film is formed by sputtering. When the density of the metallic thin film is increased, the environmental stress tolerance of the biosensor can be improved, thereby providing the metallic thin film that is difficult to be stripped and increasing its durability in the use thereof. Also, the metallic thin film 3 may be formed into a multi-layered structure in which, for example, a chromium (Cr) film is firstly formed on the surface of the transparent rod and, in turn, a golden (Au) film is formed thereon.

In the structure of the metallic thin film 3, when a multi-layered structure using a layer of a thin Cr film as a bottom layer, it is important to form the layer into an extremely thin layer since said layer of the Cr film is not suitable for plasmon resonance so much. Specifically, it is preferred to form said layer of the Cr film so as to be in the range from 0.1 to 10 nm, more preferably, in the range from 1 to 5 nm.

The metallic reflector 40 has a function of reflecting the light entered into the transparent rod. For the material thereof, a material that can maintain at least this function is employed. For example, two layered structure comprising Ag or Al and an Au layer provided thereon (outer side) may be used. In particular, Ag or Al is readily oxidized in the air and the metallic reactor can be prevented from being oxidized by providing an Au layer having oxidization stability on the surface of Ag or Al. Furthermore, to provide this metallic reflector 40 having a stable reflection factor of this metallic reflector 40, the reflector is formed so as to have the thickness in the range from 100 nm to 2,500 nm, more preferably, in the range from 500 nm or above. When the thickness is so thick that the reflector could be exfoliated from the rod depending on the outer diameter of the transparent rod, therefore, it is preferred to form the reflector to be 2,500 nm or less. In one example, the reflector may be formed so as to have a two layered thin films structure in which an Ag layer is formed on the inner side and an Au layer is formed thereon and the thickness of the metallic thin layer may be 550 nm.

The length of the region where the transparent rod is coated by the metallic thin film on which the organic substance layer 4 is formed may be appropriately selected but, for example, it is preferred to be approximately 2 to 50 mm, more preferably, approximately 5 to 20 mm.

The region where the organic substance layer in the transparent rod 3 is the region where the substance to be immobilized to be fixed and, thus, when the length thereof is so short the sensitivity of the sensor would be poor. On the contrary, when the length is so long that problems of breaking or chipping during the operation thereof would readily occur as well as a large quantity of a sample might be required at the detection.

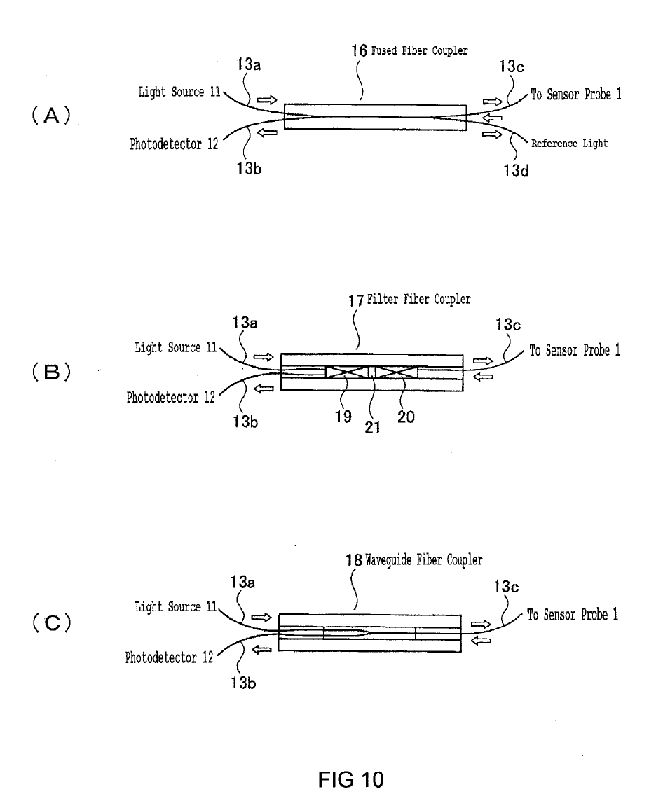

FIG. 9 shows the relationship between the length of the region where the organic substance layer is formed, i.e., the region on which the metallic thin film is coated: the sensing part, that is, the sensing length and the depth at the resonance wave length. As obvious from this figure, the longer the sensing part of the optical fiber type biosensor is, the larger the attenuation of the reflected light is and the SPR resonance waveform in the result of the measurement would be sharpened. In other word, the depth at the resonance wave length in the graph “Sensing length—Depth at the resonance wave length” would be deeper. On the other hand, if the length of this sensing part is 5 mm or more, in particular, 10 mm or more, the amount of change of the resonance strength, i.e., tilt angle in the graph “Sensing length—Depth at the resonance wave length” would be obtuse and the above mentioned would be derived due to the length being too long. Accordingly, in order to avoid the problems during the use while maintaining the detective function, it is desired that the length of the transparent rod on which the organic substance layer 4 is to be formed so as to be approximately 5 to 20 mm, more preferably, approximately 8 to 13 mm.

The substance to be immobilized is not specifically limited so long as it is a reactive layer 4a comprising a reactive substance that interacts with a predetermined substance to be detected 7. For the reactive substance, for example, a biological substance such as various kinds of antigens, antibodies, proteins and sugars may be employed.

The antigen or antibody to be used as the biological substance may be, for example, an antigen or an antibody causing an allergy and, in this case, antigens of, for example, Acari, cedar pollen, ragweed pollen, white birch pollen, mugwort pollen or antibodies recognizing these antigens may be used.

Also the antigen or antibody to be used as the biological substance may be, for example, antigens or antibodies for detecting residual agricultural chemicals or residual antibiotics in processed food and, in this case, the antigens of, for example, internal residual antibiotics of cultured fishes and shellfishes or residual agricultural chemicals in food or vegetables or the antibodies recognizing these antigens may be used.

Further, the antigen or antibody to be used as the biological substance may be, for example, antigens or antibodies of viruses or disease-causing bacteria causing food poisoning or communicable diseases and, in this case, for example, the antigens of O-157 or E. coli causing food poisoning or Hemophilus influenzae and the like causing communicable diseases or the antibodies recognizing these antigens may be used.

The photo reactive group contained in the photo cross linking agent is, for example, a functional group emitting radicals by irradiating light and forms a bond with a functional groups such as an amino group or a carboxyl group or carbon atoms constructing an organic compound by the radicals. For such a photo reactive group, any functional group that induces a bond formation with an water soluble polymer and a biological substance or the metallic thin film 3 by the light irradiation and it is not specifically restricted. For the photo reactive group, for example, an azide group is included, more specifically, a phenyl azide group and a benzoyl group are included. Among them, the phenyl azide group is the most preferable.

When the biological substance is immobilized by using the water soluble polymer having the photo reactive group on the metallic thin film 3, the biological substance can be immobilized by radical reaction initiated as ultraviolet rays is irradiated. Therefore, there is the advantage of no requirement to limit the kind of the biological substance to be an object (the reactive layer 4a comprising the reactive substance carried by the substance to be immobilized).

Further, at the formation of the organic substance layer in which the substance to be immobilized by the photo immobilizing agent, the layer may be provided by: a water soluble polymer layer having the effect of nonspecific adsorption of the substance to be immobilized and/of the substance that is specifically reacted with the substance to be immobilized onto the surface of the substrate is formed and, in turn, the mixture of the substance to be immobilized and the photo cross linking agent having at least two or more of photo reactive groups in one molecule is coated followed by the light irradiation.

By using the water soluble polymer, it is possible to prevent foreign substances from being “nonspecifically adsorbed” in the organic substance layer 4. Herein, “nonspecific adsorption” means the phenomenon of the adsorption and bonding of substances other than the substance to be detected to the organic substance layer 4 in the adsorption, covalent bond or ion bond ways regardless of the bond of the substance to be detected with the reactive substance. Since this nonspecific adsorption affects the properties of the sensor, it is desirable to be controlled as much as possible.

### Method for Producing Optical Fiber Type Biosensor

The method for producing the optical fiber type biosensor of the first embodiment according to the present invention comprises the steps of preparing the transparent rod 2; forming the metallic reflector 40 on the end surface 2a of one end of the transparent rod 2; forming the metallic thin film 3 on the outer circumferential surface of the one end of the transparent rod 2; and forming the organic substance layer 4 in which the photo immobilizing agent containing the photo cross linking agent and the substance to be immobilized.

The step of forming the organic substance layer 4 comprises the steps of dip coating an applying solution having a biological substance and the photo immobilizing agent on the metallic thin film 3 of the outer circumferential surface of the transparent rod 2 directly or through a thiol layer; and immobilizing the dip coated applying solution by the light irradiation to form the organic substance layer 4.

In the dip coating, a metallic rod provided with the metallic reflector and the metallic thin film is immersed in the applying solution having the biological substance and the photo immobilizing agent for the required time and, then, the rod is pulled out of the applying solution at the set rate. This process is repeated several times as required to provide the predetermined film thickness. This dip coating may be carried out at an increased or decreased pressure other than at a room temperature under the atmospheric pressure, as needed.

Particularly in the optical fiber type biosensor according to the present invention, since it is desirable that the substrate is a rod shaped metallic rod and the organic substance to be formed on the metallic thin film is formed so as to have a thickness of 200 nm or less in view of the accuracy of the sensor, the dip coating is the most suitable for forming the organic substance layer. Specifically, the dip coating conducted by using the applying solution comprising 0.3 to 0.003% by weight of the substance to be immobilized and 5% of the photo immobilizing agent based on the substance to be immobilized can provide the organic substance layer having a uniform thickness of 200 nm or less to be formed. For example, when the bovine serum albumin (BSA) antibody is employed as the substance to be immobilized, the dip coating is carried out with an aqueous solution of 0.03% by weight of the BSA and 0.0015% by weight of the photo immobilizing agent as an applying solution, thereby providing the organic substance layer having a uniform thickness of 200 nm or less to be formed.

More specifically, the method for producing the optical fiber type biosensor according to the present invention is as follows: (a) A transparent rod made of a silica glass having an outer diameter of about 400 micrometers is prepared. The transparent rod can easily be obtained by, for example, a commercially available optical fiber from which the clad layer is eliminated by an organic solvent and the like. (b) Next, the metallic reflector 40 having a thickness of about 500 nm or more is formed on the end surface of the transparent rod by sputtering. For the metallic reflector 40, a two layered structure of silver (Ag)/gold (Au) is employed. (c) Then, the metallic thin film 3 having a thickness of about 50 nm is formed on the side surface of the transparent rod by sputtering. In order to provide this metallic thin film to be uniform, it is desirable that the transparent rod is not only revolved but also rotated within a chamber during the sputtering. For the metallic thin film 3, single layer structure of gold (Au) may be used and two layered structure of a chromium (Cr) film having a thickness of about 3 nm and a golden (Au) film having a thickness of about 47 nm formed thereon may also be used. (d) Next, 0.05% by weight of a water soluble polymer having a photo reactive group as a fixing agent and 0.1% weight of bovine serum albumin (BSA) antibody or antigen thereof are dissolved into a purified water to produce a photo reactive solution. (e) Then, the transparent rod to which the metallic thin film 3 is subjected to the dip coating with this solution.

When the azide group is used as a photo reactive group, ultraviolet light is preferable as a light and the ultraviolet rays (wavelength of 300 nm to 400 nm) are irradiated to the organic substance layer 4 to immobilize BSA antibody or antigen onto the metallic thin film 3.

Also, the surface of the metallic thin film 3 may be subjected to thiol treatment to further increase the reactivity of thereof with the photo reactive group. For example, after the thiol treatment of the metallic thin film 3 with 1 mM mercaptethanol, the metallic thin film 3 may be immersed into the photo reactive solution produced in above to apply dip coating to the surface thereby followed by irradiation to immobilize. Accordingly, an optical fiber type biosensor having the BSA antibody or antigen can be provided.

Sensor Measurement System to which the Optical Fiber Type Biosensor is Applied

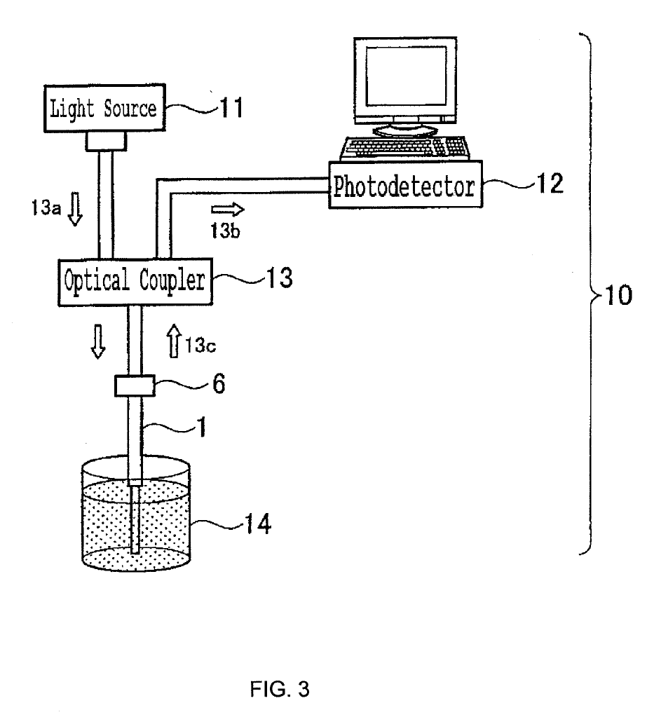

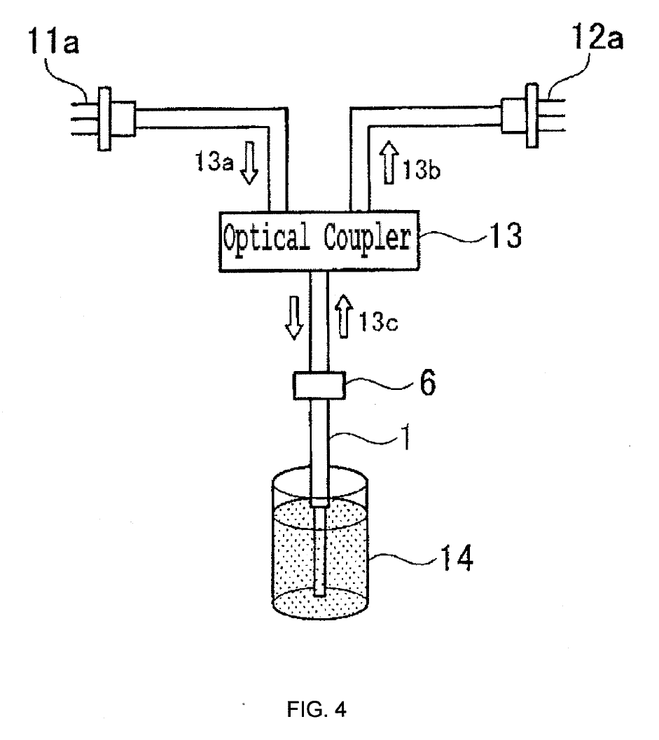

FIG. 3 shows a schematic arrangement view illustrating a simple sensor measurement system to which the optical fiber type biosensor of the first embodiment according to the present invention. FIG. 4 shows a schematic view illustrating a simple sensor measurement system to which the optical fiber type biosensor of the first embodiment according to the present invention, in which a laser diode, LD or light emitting diode, LED is employed as a light source and a photodiode, PD is used as a detector.

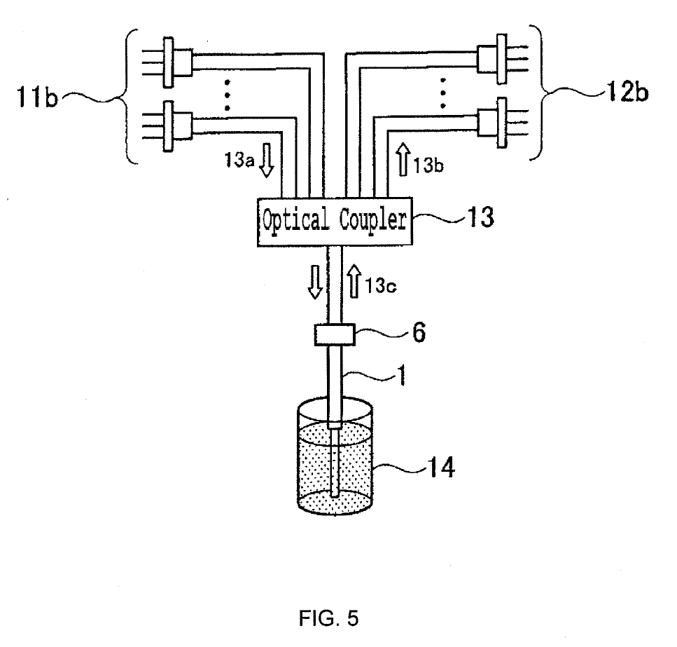

FIG. 5 shows a schematic view illustrating a simple sensor measurement system to which the optical fiber type biosensor of the first embodiment according to the present invention, in which laser diode, LD, arrays or light emitting diode, LED, arrays are employed as a light source 11 and photodiode, PD, arrays are used as a detector 12.

A simple sensor measurement system to which the optical fiber type biosensor of the first embodiment according to the present invention is, as shown in FIG. 3, a sensor measurement system 10 for detecting intersubstance action by applying surface plasmon resonance phenomenon, wherein said system 10 comprises a sensor probe 1 including a biosensor for detecting the intersubstance action by surface plasmon resonance phenomenon; a sensor probe holder 6 for holding the sensor probe 1; a light source 11 for entering a light to the sensor probe 1; a photodetector 12 for detecting the light reflected from the sensor probe 1; and a light coupler 13 for propagating the entered light from the light source 11 and the reflected light from the sensor probe 1 to the photodetector 12. Herein, the sensor probe 1 measures the sample to be measured 14 while being immersed in the sample.

In a simple sensor measurement system 10 to which the optical fiber type biosensor of the second embodiment according to the present invention, in which the light source 11 may comprise a laser diode or light emitting diode 11a and the photodetector 12 may comprise a photodiode 12a.

In a simple sensor measurement system to which the optical fiber type biosensor of the third embodiment according to the present invention, the light source 11 may comprise a laser diode or light emitting diode array 11b and the photodetector 12 may comprise a photodiode array 12b as shown in FIG. 5.

In one example, a white light source is used as the light source 11, a small spectroscope (wavelength ranging from 350 nm to 1,050 nm) is used as the photodetector 12, a multi mode quartz optical fiber having the core diameter of about 400 micrometers is used as optical fibers 13a, 13b and 13c, wherein the sensor probe 1 is connected with the multi mode quartz optical fiber by the use of the sensor probe holder 6, and a multi mode optical fiber type coupler having the core diameter of about 400 micrometers is used as the optical coupler 13.

The above optical coupler 13 propagates the entered light from the light source 11 to the sensor probe 1 and the reflected light from the sensor probe 1 to the photodetector 12 and, thus, it is desirable to have lower propagation loss in the predetermined wavelength band.

A specific example of the light coupler 13 is shown in FIG. 10. FIG. 10 (A) shows a fused type fiber coupler 16, FIG. 10 (B) illustrates a filter type fiber coupler 17 and FIG. 10 (C) shows a waveguide type fiber coupler 18.

In any of these fiber couplers 16, 17 and 18 shown in FIG. 10, the entered light from the light source 11 is conducted to the fiber coupler 16, 17 or 18 through the optical fiber 13a, transmitted the fiber coupler 16, 17 or 18 and entered the sensor probe 1 through the optical fiber 13c. The light entered the sensor probe 1 is reflected at the metallic reflector 4, conducted by the optical fiber 13c, transmitted the fiber coupler 16, 17 or 18, conducted by optical fiber 13b and propagated to the photodetector 12. In particular, in the fused fiber coupler 16, the optical fiber 13d can be used as a referential light. The filter fiber coupler 17 shown in FIG. 10 (B) can be constructed by the combination of lends 19 and 20 with a filter 21.

Particularly in the optical fiber type biosensor according to the present invention, the light from the light source can easily and certainly be entered the transparent rod by using the fiber type optical coupler. That is to say, it eliminates to position the propagation root required in the optical coupler using a prism.

By using the simple sensor measurement system to which the optical fiber type biosensor of the first embodiment according to the present invention, not only the components or concentrations of the solution of the sample to be measured 14 but also the thickness of the organic substance layer 4 coupled to the sensor probe 1 and the presence and absence of the antibody or antigen of the objective substance to be detected 7 or the rate of the immune combination reaction and the like can be observed in real-time at a high sensitivity as an amount of change of SPR resonance wavelength by the reactive layer 4a comprised by the reactive substance such as an antigen or antibody carried on the sensor probe 1.

In case where the reactive substance to be detected is limited, the optical fiber type biosensor measurement system is constructed to have the simple measurement structure shown in FIG. 4. As shown in FIG. 4, the laser diode or light emitting diode 11a having the predetermined wavelength is used as the light source 11 and a photodiode and the like is used as the photodetector 12.

Furthermore, as shown in FIG. 5, for the LD or LED of said light source 11, a laser diode array or light emitting diode array 11b comprised by a structure having two or more of parallel arrays in which each diode having different wavelengths may be employed. In this case, the photodiode array 12b comprising a structure having two or more of parallel arrays would be employed to match the predetermined wavelength of the light source in the photodetector 12. In any one of simple measurement structures, the amount of change in the strength of light output is detected.

### One Example of Combination Reaction by the Observation System by the Optical Type Biosensor

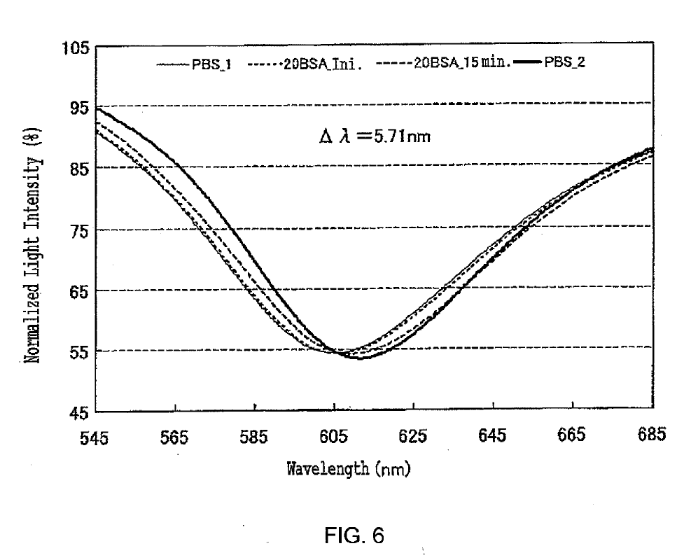

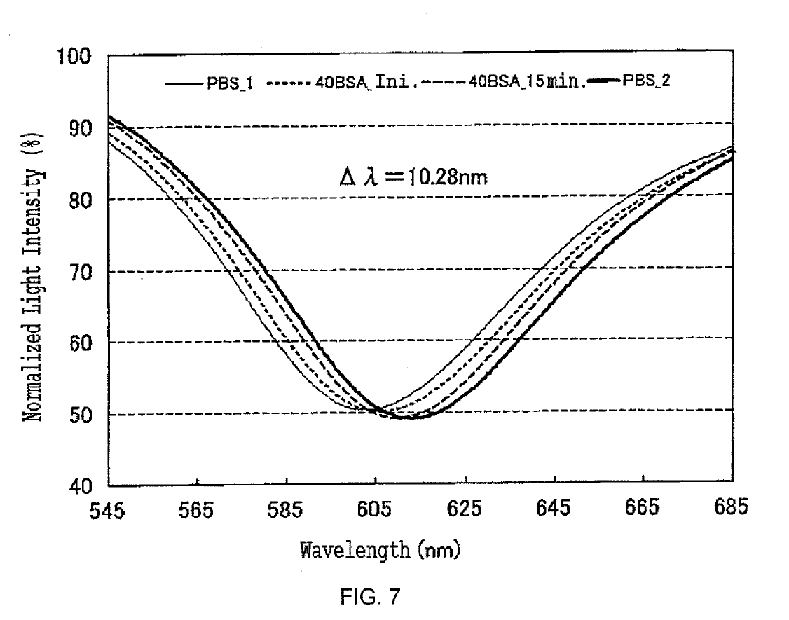

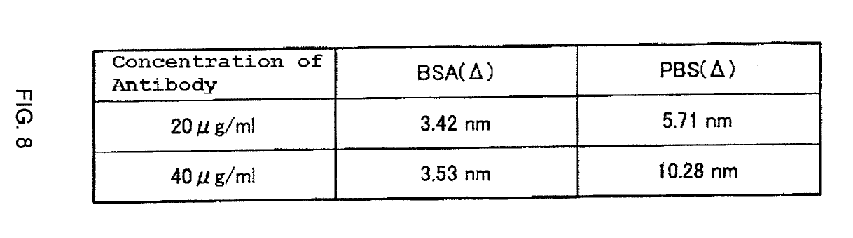

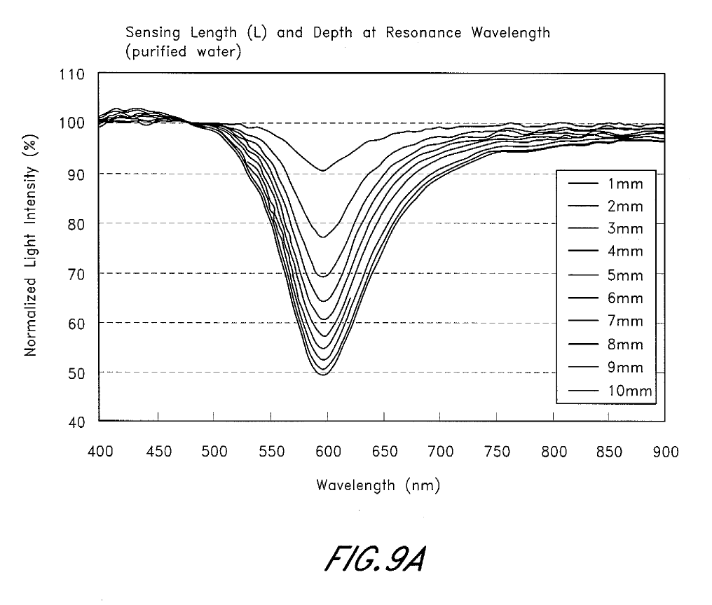

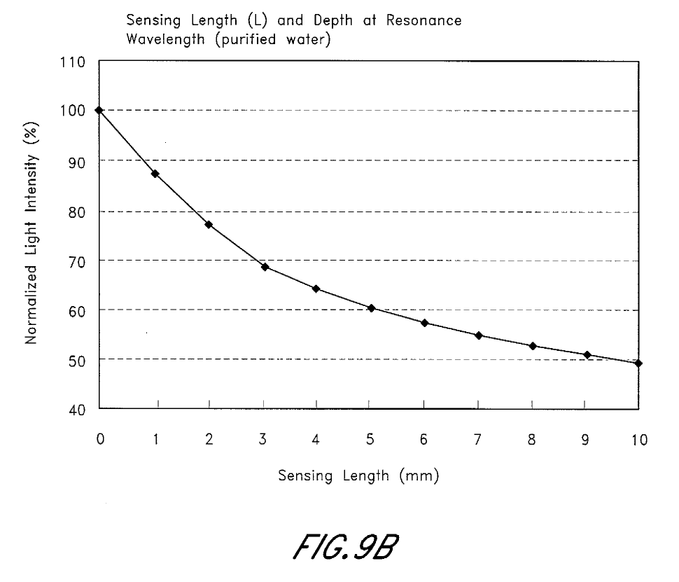

FIG. 6 shows the observation results of the measurement of Sample solution A of the sample to be measured 14 by the use of the optical fiber type biosensor of the first embodiment according to the present invention. FIG. 7 shows the observation results of the measurement of Sample solution B by the use of the optical fiber type biosensor of the first embodiment according to the present invention. FIG. 8 shows a measurement data for Sample solutions A and B of the sample to be measured 14 measured by the use of the optical fiber type biosensor of the first embodiment according to the present invention. The combination reaction time for SPR sensor antibody with BSA antigen to be immobilized was 15 minutes.

FIG. 6 is an exemplified graph of SPR wavelength features before and after the combination reaction of BSA antibody-antigen detected by the observation system shown in FIG. 3 in above when the sensor probe 1 of the optical fiber type biosensor carrying BSA antigen is immersed in Sample solution A of the sample to be measured 14 containing BSA antibody.

As shown in FIG. 6, Graph PBS_{—}1 shows the feature of the SPR wavelength observed when the sensor probe 1 is immersed in a phosphate buffer solution (PBS) before the combination reaction; BSA_initiation and BSA_{—}15 min. each shows the features of the SPR wavelength at the initial of the combination reaction and 15 minutes after the initiation when the sensor probe 1 is immersed in Sample solution A containing BSA antibody; and Graph PBS_{—}2 shows the feature of the SPR wavelength observed in the case where the sensor probe 1 which has been pulled up after the combination reaction is washed with the PBS buffer solution and again immersed in the PBS buffer solution. Herein, the wavelength with which the minimum normalized optical strength is provided in the features of the SPR wavelength is defined as “ ”SPR resonance wavelength.

The concentration of BSA antibody of Sample solution A of the sample to be measured 14 used herein was 20 micrograms/ml. When The BSA (delta) is defined as the difference between the SPR resonance wavelength at Graph BSA_initiation and Graph BSA_{—}15 min. and the PBS (delta) is defined as the difference between the SPR resonance wavelength at Graph PBS_{—}1 and the SPR resonance wavelength at PBS_{—}2, BSA (delta)=3.42 nm and PBS (delta)=5.71 nm as shown in FIGS. 6 and 8.

FIG. 7 is an exemplified graph of the features of the SPR wavelength before and after the combination reaction of BSA antibody-antigen detected by the observation system shown in FIG. 3 when the sensor probe 1 of the optical fiber type biosensor carrying BSA antigen is immersed in Sample solution B of the sample to be measured 14 containing BSA antibody.

The concentration of the BSA antibody of Sample solution B of the sample to be measured 14 herein used was 40 micrograms/ml and the combination reaction time was 15 minutes. In this case, as shown in FIGS. 7 and 8, BSA (delta)=3.53 nm and PBS (delta)=10.28 nm.

As obvious from FIGS. 6 through 8, by using the optical fiber type biosensor of the first embodiment and its measurement system according to the present invention, an objective antigen or antibody to be sensed can be measured at high sensitivity with a sample solution even in a small amount.

The observed amount of change in wavelength PBS (delta) by the SPR resonance was almost proportional to the concentration of the BSA antibody of the sample solution of the sample to be measured 14 and it was shown that the concentration of the antibody could be quantitatively and accurately detected.

According to the biosensor, the method for producing a biosensor and the sensor measurement system of the present invention, a photo immobilizing agent containing a biological substance such as a protein and a photo cross linking agent having a photo reactive group are applied to the outer circumferential surface of the transparent rod by dip coating, and an organic substance layer is formed by irradiating the ultraviolet rays to immobilize the layer, thereby providing the detection of the index of refraction, concentration, proteins, antibody-antigen reaction and the like of the sample to be measured at a high sensitivity by using surface plasmon resonance phenomenon.

### Other Embodiments

Although the present invention has been described with reference specific embodiments above, it should be understood that the description and the accompanying drawings comprising one part of this specification are not intended to limit the scope of the present invention. Various alternative embodiments, examples and operational techniques would be apparent from this description to a person skilled in the art.

Accordingly, the present invention obviously includes a wide variety of embodiments which are not described herein. Therefore, the scope of the present invention falls only in the scope of the claims.

What is claimed is:

1. A biosensor comprising:
a transparent rod;
a metallic reflector formed on one end surface of said transparent rod;
a metallic thin film formed on the outer circumferential surface of said end of said transparent rod; and
an organic substance layer containing a substance immobilized by a photo immobilizing agent on said metallic thin film of said outer circumferential surface, wherein the material of said transparent rod is a quartz glass or an optical glass and said metallic thin film being a multi-layered structure comprising a chromium film and a film of gold (Au), silver (Ag), zinc (Zn), aluminum (Al) or potassium (K) formed on said chromium film.

2. The biosensor of claim 1, wherein said organic substance layer is formed by dip coating.

3. The biosensor of claims 2, wherein said photo cross linking agent has two or more photo reactive groups and at least one of photo reactive groups is an azide group.

4. The biosensor of claims 3, wherein said photo immobilizing agent comprises an aqueous solution of polyethylene glycol (meth)acrylate.

5. The biosensor of claims 4, wherein said substance immobilized comprises a polypeptide, a protein, a nucleic acid, a lipid or a cell.

6. A method for producing a biosensor comprising the steps of:
providing a transparent rod;
forming a metallic reflector on one end of the surface of said transparent rod;
forming a metallic thin film on the outer circumferential surface of said end of said transparent rod; and
forming an organic substance layer comprising an immobilized substance on said metallic thin film of said outer circumferential surface, wherein the material of said transparent rod is a quartz glass or an optical glass and wherein said metallic thin film has a multi-layered structure comprising a chromium film and a film of gold (Au), silver (Ag), zinc (Zn), aluminum (Al) or potassium (K) formed on said chromium film, and wherein said organic substance layer is formed by dip coating said transparent rod comprising the metallic film in a solution containing a photo immobilizing agent comprising a photo cross linking agent and the substance and irradiating ultraviolet light on said metallic thin film.

7. The method for producing a biosensor according to claim 6, wherein said metallic thin film is a multi-layered structure in which the most internal layer is a chromium film.

8. A sensor measurement system for detecting an interaction using surface plasmon resonance, comprising:
a sensor probe comprising the biosensor as defined in claim 5;
a sensor probe holder for holding said sensor probe;
a light source;
an optical coupler for transporting the light from said light source to said sensor probe and transporting reflected light from said sensor probe to a photodetector; and
a photodetector for detecting said reflected light.
